(19) United States
(12) Patent Application Publication
(10) Pub. No.: US 2026/0316438 A1
(43) Pub. Date: Oct. 15, 2026

(54) METHOD AND SYSTEM FOR PULSED LIGHT DEADHESION FOR METAL-TRANSPARENT AND TRANSPARENT-TRANSPARENT SUBSTRATES ATTACHED WITH ADHESIVES

(71) Applicant: THE REGENTS OF THE UNIVERSITY OF CALIFORNIA, Oakland, CA (US)

(72) Inventors: Christopher J. BARDEEN, Riverside, CA (US); Touhid Bin ANWAR, Riverside, CA (US); Kerry Hanson, Riverside, CA (US)

(73) Assignee: THE REGENTS OF THE UNIVERSITY OF CALIFORNIA, Oakland, CA (US)

(21) Appl. No.: 18/998,700

(22) PCT Filed: Jul. 26, 2023
(86) PCT No.: PCT/US2023/071046

§ 371 Date: Jan. 27, 2025

Related U.S. Application Data
(60) Provisional application No. 63/392,537, filed on Jul. 27, 2022.
(60) Provisional application No. 63/500,459, filed on May 5, 2023.

(51) Int. Cl. B32B 43/00

(52) U.S. Cl. CPC B32B 43/006; B32B 2307/41; B32B 2307/412; B32B 2307/7375; B32B 2310/0843

(57) ABSTRACT

A method and system are disclosed for debonding of an adhesive layer. The method includes transmitting a source of pulsed light through a first substrate toward the adhesive layer, the first substrate being an optically transparent substrate, and the adhesive layer being arranged between the first substrate and a second substrate.

### CROSS-REFERENCES TO RELATED APPLICATIONS

This application claims priority to U.S. Patent Application Ser. No. 63/392,537 filed on Jul. 27, 2022, and U.S. Patent Application Ser. No. 63/500,459 filed on May 5, 2023, the entire content of both of which is incorporated herein by reference.

### GOVERNMENT CLAUSE

This invention was made with government support under grant number N00014-18-1-2624 awarded by the Office of Naval Research. The government has certain rights in this invention.

### TECHNICAL FIELD

The present disclosure generally relates to a method and system for pulsed light, for example, pulsed laser deadhesion for metal-transparent and transparent-transparent substrates attached with adhesives.

### BACKGROUND

Many manufacturing and construction processes rely on joining materials using mechanical fasteners or glues. The relatively high bond strengths combined with low weights of chemical adhesive has made the manufacture of chemical adhesives a billion-dollar industry. Ideally, an adhesive, like a bolt, could be used for reversible joining where a strong bond could be formed and later broken in a relatively rapid and convenient way. Bond-forming has been the main focus of research in the field, while the debonding of adhesives has received less attention. For relatively weak adhesions, debonding can be achieved by physical separation, but when the adhesive bond is of comparable strength to the substrate, physical separation is likely to fracture the substrate as well as the bonding layer. Strategies for debonding strong adhesives usually rely on the inclusion of thermally expansive materials or other elements that can generate internal heat in response to external electric or magnetic fields. In most cases, the debonding process is relatively slow (seconds to minutes) and requires the use of a large secondary device, like a heater or magnet, in close proximity to the glued object.

Light provides a nonthermal input that can be used for debonding adhesives across relatively large distances. There are multiple strategies for light-induced debonding, all of which require the use of custom-made photosensitive adhesives. Light-induced polarity changes of photochromic molecules like spiropyrans, diarylethenes, and donor-acceptor Stenhouse adducts can be used to modify the relatively weak adhesion between a doped polymer film and another solid surface. Molecular guest-host interactions can be modified by light to create switchable adhesion between functionalized surfaces. Photoisomerization and/or photothermal heating can lead to softening or even liquification of the adhesive layer, followed by debonding. Using this strategy, the adhesive layer can be composed of a light-sensitive polymer, molecular film, or a gel. In most cases, the specially designed molecules used as adhesives have not demonstrated the strength and reproducibility of commercial glue formulations. Furthermore, the debonding usually requires a chemical reaction and in general takes minutes using standard lamp sources. In addition, the photochemistry is usually initiated by ultraviolet or visible wavelengths, so at least one of the glued pieces must be transparent at those wavelengths.

### SUMMARY

Light-induced debonding usually relies on specialized photosensitive adhesives that undergo melting transitions. However, when high power light pulses are absorbed by a thin interfacial layer, a rapid phase transition, like melting, pyrolysis, or vaporization, can be induced by the localized heating. In view of the above, it would be desirable to have a system and method that can generate debonding with light-induced interfacial phase transitions.

In accordance with an embodiment, a method is disclosed for debonding of an adhesive layer, the method comprising: transmitting a source of pulsed light through a first substrate toward the adhesive layer, the first substrate being an optically transparent substrate, and the adhesive layer being arranged between the first substrate and a second substrate.

In accordance with an embodiment, a system is disclosed for debonding of an adhesive from a substrate, the system comprising: a first substrate, the first substrate being an optically transparent substrate; an adhesive layer arranged between the first substrate and a second substrate; and wherein the first substrate and the adhesive layer are configured to receive a source of pulsed light that is transmitted through the first substrate and the adhesive layer to the second layer.

### BRIEF DESCRIPTION OF THE DRAWINGS

FIG. 1 is an illustration of a single shot of pulsed light, for example, a laser pulse that induces melting at the metal-adhesive interface, resulting in a clean break between the metal and plastic substrate.

FIG. 2 is a schematic diagram of a setup for a system and method for nanosecond pulsed laser debonding.

FIGS. 3A and 3B are illustrations of fraction of samples that debond after a single laser pulse plotted versus the laser pulse fluence at 1064 nm (FIG. 3A) and 532 nm (FIG. 3B), and wherein the different curves reflect different loading conditions: higher loading requires lower laser fluences. Solid lines are fits to the data points using the sigmoidal function defined in Equation (1) as disclosed herein.

FIGS. 4A-4C are optical microscopy images of 5 mm diameter Al surface before gluing (FIG. 4A); Al surface after physical debonding by the application of a 10 MPa load, leaving residual adhesive and PMMA debris on the surface (FIG. 4B); and Al surface after laser debonding (0.78 J/cm²) with minimal residue left behind (FIG. 4C).

FIGS. 5A-5C are SEM images of an Al surface before gluing (FIG. 5A); a bare Al surface after exposure to a single laser pulse (0.78 J/cm²), showing surface changes consistent with melting (FIG. 5B); and an Al surface after a single laser pulse (0.78 J/cm²) has detached the glued PMMA piece (FIG. 5C). The dark and light regions correspond to organic insulating regions and bare metal, respectively.

FIG. 6 is an illustration of the dependence of E_{debond} on applied load (MPa) for 1064 nm pulses, showing that larger loads require less energy to debond. The solid lines are linear-least-square fits using Equation (5) and Equation (6).

FIG. 7 is a table that illustrates fitting parameters extracted from using Equation (1) to fit the debonding data for 1064 nm and 532 nm wavelengths at different loading conditions. The parameters have an estimated uncertainty of ±10%.

FIG. 8 is an illustration of an adhesively bonded aluminum-glue-PMMA sample. The average diameter of the threaded aluminum piece is 5.09±0.03 mm and the PMMA thickness is approximately 3.5 mm.

FIG. 9 is an illustration of an optical microscope image of the sample viewed from the side, showing the adhesive layer thickness between two Al plates is approximately 100 μm.

FIGS. 10A-10D illustrate a sample preparation and laser irradiation for home-built Si-EVA-glass assembly that mimics a solar panel, wherein EVA is laminated between glass slide and Si wafer under a load of 300 g (FIG. 10A); Glass-EVA-Si wafer attached with another piece of glass slide to facilitate laser irradiation under external load (FIG. 10B); Laser irradiation setup for raster scanning of the home-built Si-EVA-glass assembly on the X-Y translation stage (FIG. 10C); and EVA separates from Si wafer after laser irradiation and sticks to the rough glass surface (FIG. 10D).

FIG. 11A illustrates laser fluence optimization for 355, 532 and 1064 nm wavelengths at constant scan speed on home-built Si-EVA-glass assembly. Results indicate that 355 nm wavelength requires the least laser fluence and external load for the detachment of EVA from Si wafer; FIG. 11B illustrates scan speed dependence optimization for 355 nm wavelength shows that 50 mm/s scan speed can result in detachment of EVA from Si wafer; and FIGS. 11C and 11D illustrate that laser irradiation at 355 nm wavelength does not melt or vaporize the silver connectors of the Si wafer.

FIG. 12A is a schematic diagram for laser debonding of metal/semiconductor materials from transparent boards attached with adhesives used in electronics and electrical devices; FIGS. 12B and 12C are illustrations of a sample before laser irradiation, where FIG. 12B is a top view and FIG. 12C is a bottom view; and FIG. 12D is an illustration of the Al piece detaching from transparent PMMA board with single shot 1064 nm wavelength laser pulse (650 mJ pulse energy).

FIG. 13A is a schematic diagram of the working principle of transparent-transparent substrate detachment with the introduction of an ultrathin absorbing layer; FIG. 13B is a chart illustrating dependence of butt-joint strength on concentration of Fluorescein-27 dye solution, and absence of thin absorbing dye layer could achieve a joint strength of up to 10 MPa whereas the strength decreased with increasing concentration of stock dye solution before spin coating; and FIG. 13C is a graph illustrating dependence of laser fluence and external load on detachment under laser irradiation at 532 nm pulsed laser irradiation.

FIG. 14 illustrates the geometry of how Top and Bottom artificial nails are glued together in a fashion similar to how a nail technician attaches an artificial nail to a client's bottom nail. This geometry is used to test artificial nail deadhesion in accordance with an embodiment.

FIG. 15 is an illustration of an experimental setup with 2-pulley system for measuring adhesive strength and pulsed laser-based deadhesion.

FIG. 16 illustrates fraction of samples that debonded plotted versus laser pulse fluence for 1064 nm pulses. The sample was Al-glue-PMMA where the glue was a 3M 2-part acrylic adhesive, basically a standard mixed epoxy. The sample was held under a 1.5 MPa load. The blue line is a fit to the data using the sigmoidal function given in Equation (1).

FIG. 17 illustrates UV-Vis absorption spectra of 3M Ethyl Cyanoacrylate (CA) Instant Adhesive dissolved in chloroform solution before polymerization (black), in solid polymerized form on a glass slide (blue) and the polymerized glue redissolved in chloroform (black). The glue has no measurable absorption at the laser wavelengths of 1064 nm and 532 nm.

FIGS. 18A-18C are reflective SEM images of a 5 mm diameter Al surface before gluing (FIG. 18A); an Al surface after physical debonding by the application of a 10 MPa load, leaving residual adhesive and PMMA debris on the surface (FIG. 18B); and an Al surface after laser debonding (0.78 J/cm²) with minimal residue left behind around the edges (FIG. 18C).

### DETAILED DESCRIPTION

Many manufacturing, construction or even some day-to-day processes rely on joining components, parts or materials using adhesives/glues. The high bonding strength of adhesives makes them a suitable alternative to mechanical fasteners in many cases due to their lower weights. Apart from being used as replacements for mechanical fasteners, they also have applications in holding lightweight materials such as artificial nails for beauty care products, or for mobile device internal parts assembly. However, there are no convenient methods available for easy and fast debonding of high strength adhesives used in such applications.

Conventional methods of debonding include but are not limited to using thermally expansive materials or elements that respond to external stimuli such as electric or magnetic fields, heat, harsh solvents, mechanical forces, etc. These methods rely on using a large device like a heater or electromagnet, or solvents that are not environmentally friendly. They also tend to be slow in action (seconds to minutes). Application of these conventional methods is often not suitable for sensitive systems. Accordingly, it would be desirable to have a method and system which can reverse the strong adhesive bonds in less than a second without exposing the system to heat or other solvents.

In accordance with an embodiment, the method and system as disclosed, can further debond an interface between the adhesive layer and one of the first substrate and the second substrate with the source of pulsed light. For example, the interface can have a width of 10 microns or less.

In accordance with another embodiment, the second substrate is optically transparent, and the method and system further include depositing an absorbing layer on one of the optically transparent first substrate or the optically transparent second substrate before applying the adhesive layer. In addition, the method and system can include detaching the adhesive layer from the one of the optically transparent first substrate or the optically transparent second substrate having the absorbing layer by inducing a phase change of the absorbing layer, the phase change being one of a melting, a pyrolysis, or a vaporization. In addition, the absorbing layer preserves colligative properties and adhesive strength of the adhesive layer during the transmitting of the source of pulsed light through the first substrate.

In accordance with an embodiment, the second substrate can be a metal substrate, and the method and system can further include detaching the adhesive layer from the metal substrate by melting a surface of the metal substrate. The source of pulsed light, for example, can be a high energy nanosecond laser pulse at one or more of 355 nm, 532 nm, and 1064 nm. In addition, the adhesive layer can be, for example, a cyanoacrylate, a 2-part epoxy, or an adhesive glue.

In accordance with another embodiment, the adhesive layer can be a glue, the first substrate can be polymethyl(methacrylate) (PMMA) and the second layer can be aluminum. The first substrate or the second substrate can be, for example, selected from one or more of a mechanical fastener, a beauty care product, a transparent circuit board, or a plastic component.

In accordance with an embodiment, the methods and systems as disclosed herein can be implemented by transmitting the source of pulsed light in one or more of a single-shot pulsed laser or a source of high intensity light, the source of high intensity light being a flash-lamp or a pulsed light emitting diode. In addition, the single-shot pulsed laser can have, for example, a duration of 1 nanosecond (ns) pulse width, a 5 ns pulse width, a 10 ns pulse width, or a duration less than a characteristic thermal diffusion time across the absorbing layer.

In accordance with another embodiment, pulsed light debonding can offer instant detachment of a transparent substrate from a metal or other transparent substrate irrespective of the type of adhesive used. For example, the method and system as disclosed preferably includes an optically transparent substrate which can allow the transmission of the pulsed light. The mechanism of debonding relies on rapid, localized heating, for example, at an ultrathin (for example, on the order of 10 microns or less) interface between the glue and one of the substrates. Since only a small volume is heated for a relatively short time, the larger structure does not experience a large temperature increase and is not damaged.

In accordance with an embodiment, to detach a metal from an adhesively bonded transparent substrate, the pulsed light will be absorbed at the metal surface, leading to surface melting of the metal and loss of adhesion. For other materials, an ultrathin absorbing layer can be deposited on the substrate before applying the glue and attaching the second piece. One of the keys to the disclosed approach is to choose an absorbing material that preserves the high adhesive strength of the glue. Instead of doping the adhesive with the light absorbing species, keeping a thin layer separated from the adhesive preserves the colligative properties of the glue. Another important ingredient is the use of high energy pulsed irradiation to impulsively heat this light absorbing layer before heat diffusion can heat the other components of the structure. This rapid heating leads to pyrolysis and/or melting and/or vaporization selectively at the absorbing layer and thus destroys the adhesive bond between the glue and the coated substrate.

In accordance with another embodiment, the light pulse characteristics can be determined by the absorbing substrate layer and the glue properties. The idea is to induce very local heating at the substrate-adhesive interface. If a thick substrate (metal, semiconductor) is the absorber, the depth of heating, denoted Lₕₑₐₜ, is given by:

$${L}_{heat} ≅ {l}_{pen} + κ {τ}_{pulse}$$

Where lₚₑₙ is the penetration depth of the light into the absorbing substrate, κ is the thermal diffusivity, and τₚᵤₗₛₑ is the pulse duration. To localize the heating, Lₕₑₐₜ should be as small as possible, which means choosing the light wavelength to minimize lₚₑₙ and using a short pulse to minimize the thermal transport term κτₚᵤₗₛₑ. The temperature rise ΔT in the Lₕₑₐₜ zone can be estimated from the following relation:

$$Δ T ≅ \frac{{E}_{pulse}}{{C}_{P} {L}_{heat}}$$

where C_{P} is the volumetric heat capacity of the interface and Eₚᵤₗₛₑ is the pulse fluence (in units of energy/area or J/cm²). From this equation, it would seem that the ideal case is to maximize the intensity Eₚᵤₗₛₑ/τₚᵤₗₛₑ, but this quantity is limited by the damage threshold of most transparent materials, leading to the constraint:

$$\frac{{E}_{p u l s e}}{{τ}_{p u l s e}} \leq 1 {0}^{12} W / {cm}^{2}$$

Together, these three equations provide general theoretical guidance for the design of a light pulse that can selectively heat the adhesive interface. Note that optimizing the debonding requires consideration of three independent parameters: light wavelength, pulse fluence, and duration.

If the adhered substrate itself is the absorber, it will typically be a metal or a semiconductor. In accordance with an embodiment, it has been illustrated that the new technology using aluminum metal as the absorbing substrate, but other metals can also be debonded from a transparent substrate. Another example is the metal body of an electronic component from a transparent circuit board. In this case, the glue would be an electronic epoxy. This application makes it possible to have reworkable circuit boards or recycle specific electronic components like chips.

If the adhered substrate is a semiconductor, it can also be impulsively heated. An example tested is the bond between a silicon wafer and ethylene vinyl acetate (EVA), which is used to encapsulate silicon photovoltaic cells. In this application, the light pulse debonds the EVA from the silicon, allowing the semiconductor to be recycled after removal of the top glass plate that is glued to it with EVA.

If the absorbing layer is an ultrathin layer between two non-absorbing substrates, lₚₑₙ is replaced by the layer thickness but all three equations above still apply. This case would apply to two plexiglass pieces that can be debonded instantly with a laser pulse, similar to an exploding bolt.

The transparent substrates can be any material, including biological tissue. One example is a thin coating of absorber applied to a fingernail, which is then coated with nail polish or has an artificial nail glued to it. In this case, the light pulse would be transmitted through the top nail and then destroy the fingernail-adhesive bond without harming the underlying fingernail.

In addition, since this method is independent of the type of adhesive applied, it can be used in a variety of applications. For example, detachment of structural components bonded with strong adhesives like cyanoacrylates, or 2-part epoxies can be done instantly. For example, applications can include light controlled transparent separation bolts, detachment of any plastic components in mobile devices, artificial nails, and beauty care or cosmetic products.

In accordance with an aspect, a source of pulsed light, for example, high energy nanosecond laser pulses at 1064 and 532 nm can debond aluminum (Al) pieces bonded to a polymethyl(methacrylate) (PMMA) surfaces by a commercial cyanoacrylate (CA) glue. The dependence of the debonding on both laser fluence (energy per area) and applied load are further disclosed herein. For example, single shot debonding occurs at fluences on the order of 0.4 J/cm² for 1064 nm and 0.2 J/cm² for 532 nm pulses. Characterization of the Al surface before and after laser impact confirms that the debonding arises from surface melting that does not damage the larger Al piece. A model of the debonding process is derived to explain the relatively weak dependence of the debonding on the applied load. The ability of single laser pulses to generate instantaneous, relatively clean breaks at the glue-metal interface may have applications when rapid detachment is desired. The method and system as disclosed can also be compatible, for example, with commercial glues that are transparent at the laser wavelength, which would allow laser debonding to be applied to a wide range of material systems.

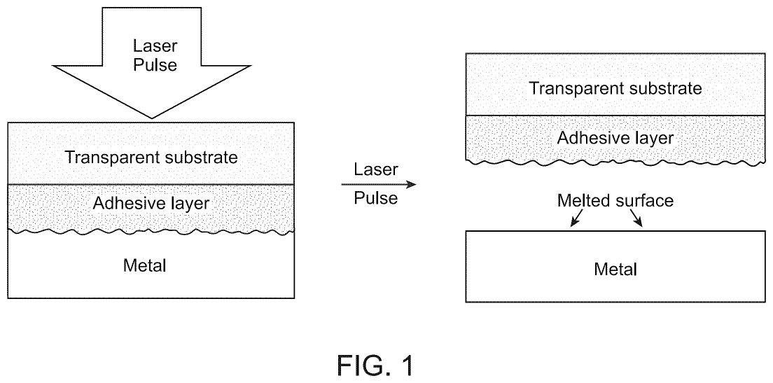

High power lasers can, for example, deposit energy with relatively high spatial and temporal resolution, providing a way to selectively heat the adhesive interface. When a laser pulse interacts with a solid surface, a variety of processes can take place, including melting, ionization, and ablation. The relative importance of these processes depends on parameters like the laser intensity, wavelength, and duration as well as the chemical structure of the solid. Much of the work in this field is focused on using very high energy pulses to physically remove material via ablation in order to texture surfaces prior to gluing. Pulsed lasers can also be used to generate shock waves to assess bonding in laminated composites, although this is usually accompanied by surface damage. In contrast, lower pulse energies can be used to disrupt the interfacial bonds between the adhesive and the metal via surface melting in one quick step, as illustrated in FIG. 1. The result, for example, can be a clean break between the metal and glue that occurs within a single pulse, assuming that the bonds do not rapidly reform. In accordance with an aspect, it would be desirable to identify conditions where the laser pulse destroys the adhesion without damaging the bonded surfaces.

In accordance with an embodiment, to implement this concept, a concentration on metal-plastic bonds was chosen because they are the most likely to have structural applications while fulfilling the requirement that one of the glued pieces is transparent at the laser wavelength. In this disclosure, the use of high-energy nanosecond laser pulses at 1064 and 532 nm to debond polymethyl(methacrylate) (PMMA) and Al surfaces held together by commercial glues with high (>1 MPa) adhesion strengths is disclosed. In accordance with an aspect, the light exposure was limited to a single laser shot, which demonstrated relatively rapid deadhesion. The dependence of the debonding on both pulse fluence (energy per area) and applied load are also disclosed. The Al surface is characterized before and after laser impact to confirm the surface melting mechanism. As illustrated in FIG. 1, a model of the debonding process is shown to explain the load dependence of the results. The ability of single laser pulses to generate instantaneous, relatively clean breaks at the glue-metal interface can have applications when rapid detachment of loads is desired, for example in certain aerospace fields where exploding bolts are used to join objects.

### Experimental

### A. Plastic-Metal Debonding

### Sample Preparation:

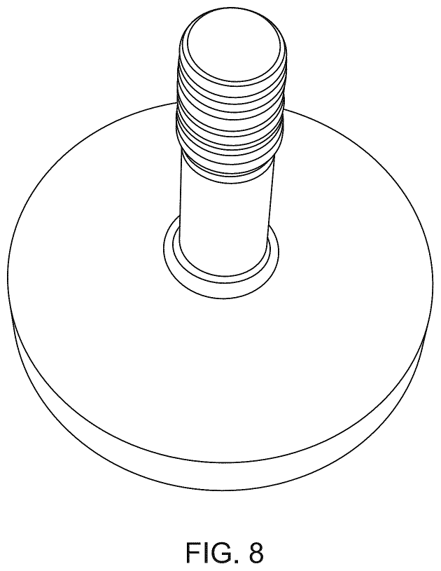

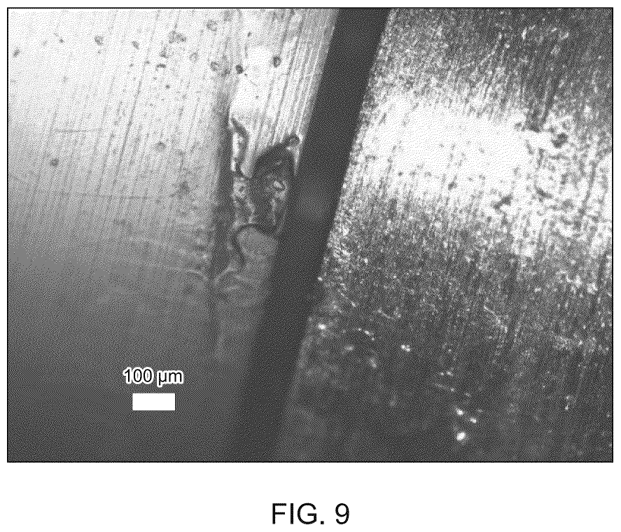

Cyanoacrylate adhesive (3M Scotch-Weld Instant Adhesive CA8) and 2-part acrylic adhesive (3M Scotch-weld DP810 Black) were used to glue 6061 aluminum cylinders to transparent polymethyl methacrylate (PMMA) substrates purchased from McMaster-Carr (part number 8531K23). The aluminum cylinders have one flat end and one threaded end that could be attached to a pulley system. The aluminum and PMMA surfaces were roughened prior to gluing to improve adhesion. The flat aluminum surface was first abraded using clean abrasive paper (Norton TufBak 220-A Sandpaper), then abraded again with fine 30 micron SiC polishing paper (3M) and finally wiped with pure acetone. The PMMA surface was wiped with a solution of 30% isopropyl alcohol in water. The glue was then placed on the PMMA surface, and the Al cylinder pressed onto it using moderate hand pressure. Excess glue was carefully wiped away and the assembly was allowed to cure in air for at least 24 hours without an attached load. The resulting bond line thickness was typically 100 microns as shown in FIGS. 8 and 9.

### Characterization:

Scanning electron microscope (SEM) images were acquired using a Nova NanoSEM (NNS450 SEM) and Hitachi TM4000PlusE II SEM. A Leica DM2700 M microscope was used to measure the bondline thickness. A trinocular stereo microscope (Amscope SW-2T13) coupled with a camera (Amscope MU900) was used for imaging the metal surface. A 1 cm path length quartz cell and an Agilent Cary 60 UV-vis spectrophotometer were used for absorption measurements in solution. For solid state measurements, the adhesive was solidified on a glass slide and an Agilent Cary 60 UV-Vis spectrophotometer was used to take the absorption spectra.

### Nanosecond Pulsed Laser Debonding:

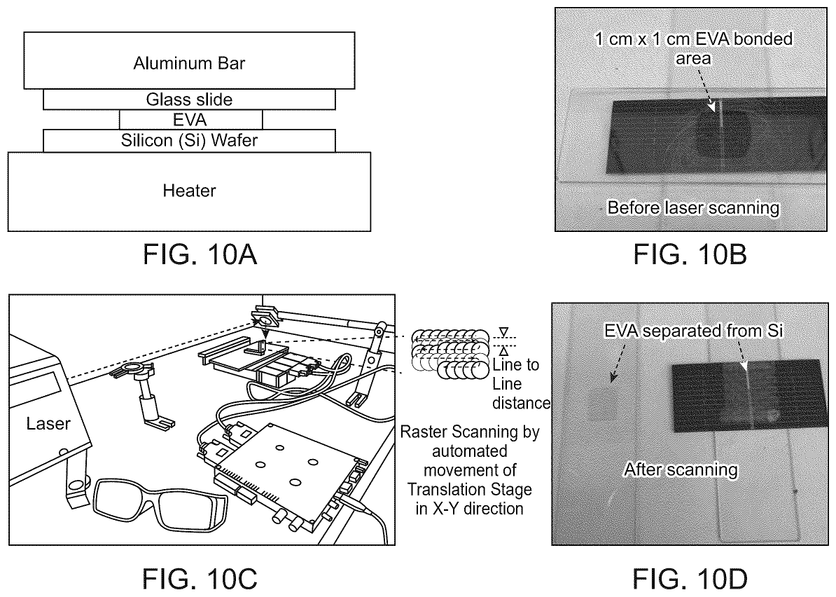

In accordance with an aspect, a single-shot pulsed laser (Amplitude Surelite II-10) with a 5 ns pulse width was used for the pulsed laser irradiation-based deadhesion. The wavelength could be changed from the fundamental at 1064 nm (maximum pulse energy ~685 mJ) to the second harmonic at 532 nm (maximum pulse energy ~285 mJ) by frequency doubling. The laser fluence was attenuated by delaying the Q-Switch to reduce the power and the pulse energy was measured with a power meter (Newport 843-R). Changing the Q-switch delay also changed the beam profile, which was approximately Gaussian. To maintain uniformity of the beam at each laser fluence, negative lenses from Thorlabs (LF1015-C for 1064 nm and LF1547-A for 532 nm) were used to ensure that the beam diameter was slightly larger (~7 mm) than the diameter of the aluminum (5 mm) for all laser powers. A custom two-pulley system (FIG. 10) was used to measure the pull-off adhesion strength and for the laser debonding experiments. The two-pulley system was calibrated with standard weights and a RoMech Digital Hanging Scale. The variable loads on the bonded samples were slowly released with the aid of an adjustable-height stage to avoid sudden force changes. For each laser fluence under each loading condition, at least 5 samples were tested to collect statistical data. For example, for greater than (>) 95% of the shots, the debonding occurred within a 1 second(s) of the pulse arrival, but in a few cases the debonding took several seconds. In accordance with an embodiment, an upper limit of 60 seconds can be used for a laser shot to qualify as a debonding event.

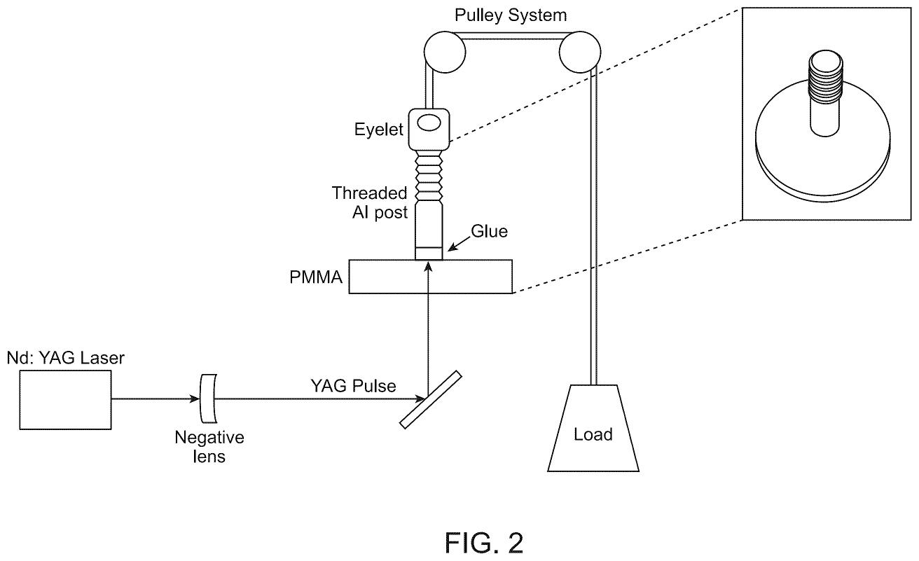

The experimental set-up for measuring laser debonding is illustrated in FIG. 2. The PMMA substrate was glued to an Al post with a threaded end that allowed it to be screwed into an eyelet attachment. This eyelet was tied to a rope running through a pulley system. At the end of the pulley system, a variable weight was attached. This system as illustrated in FIG. 2 tests the mechanical strength of the Al-glue-PMMA structure by attaching different loads to the end of the rope. It was found that the maximum adhesive strength depended on time. Most companies report a maximum load but not how long the glue can sustain this load. For example, the cyanoacrylate bond could withstand loads above 10 MPa but only for a few minutes, after which it failed. In accordance with an aspect, tests were limited to maximum load levels for which the bond survived for at least 12 hours. For example, for cyanoacrylate glue, the maximum load was limited to approximately 5 MPa, somewhat below the maximum load reported by the manufacturer for Al—Al bonds (14.48 MPa) and polyvinyl chloride (PVC)-polyvinyl chloride bonds (6.89 MPa).

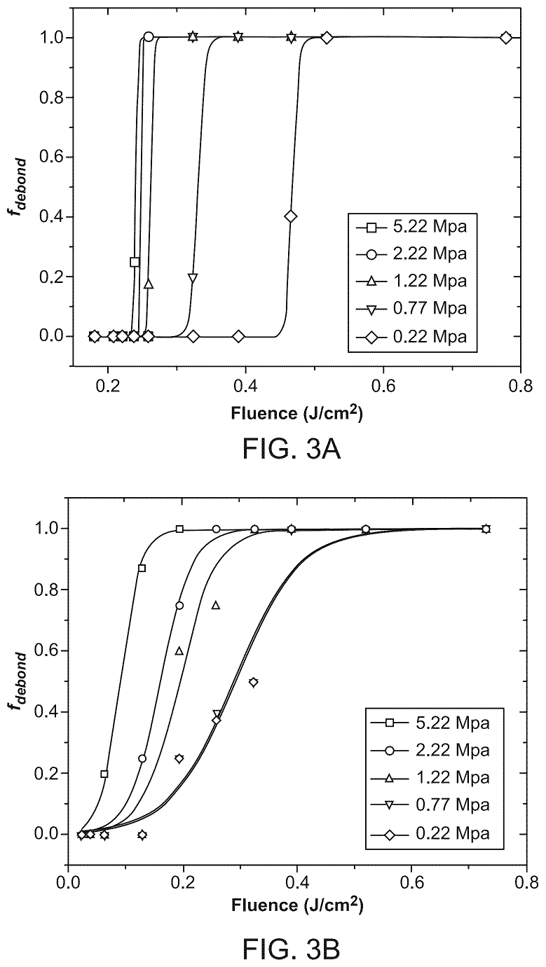

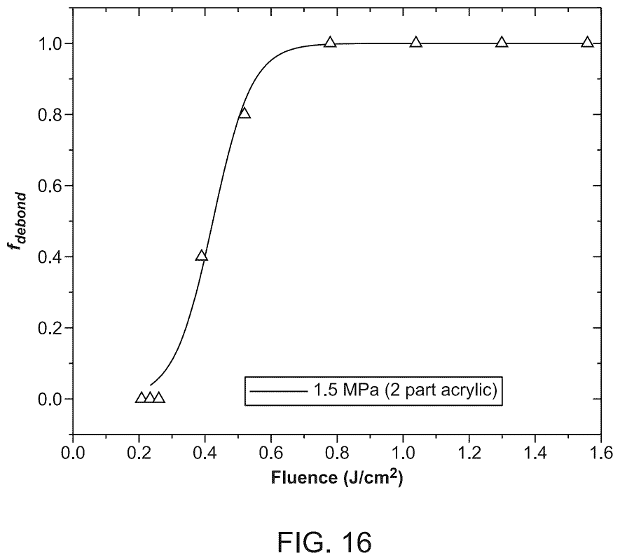

In accordance with an embodiment, a stable Al-glue-PMMA sample was obtained and subjected to a single laser shot. Bond failure was observed by seeing if the weight dropped due to loss of Al-PMMA adhesion. In general, the bond failed within milliseconds of the pulse arrival, as judged by video analysis. The experiment was repeated multiple times for a fixed pulse energy and load in order to determine the fraction of samples that debonded under these conditions. Typically, multiple trials (5 or more) were performed for each set of conditions. Then the incident laser fluence was changed by delaying the laser Q-switch to reduce the power and the experiment was repeated for the same load. Changing the Q-switch delay also changed the beam profile, so for each pulse energy, the optics were adjusted in order to maintain a constant beam radius. For laser pulse energies, the center-to-edge intensity decrease across the 5 mm Al surface, for example, ranged from approximately 60% to approximately 95% before optical adjustment but was held constant at 65% after adjustment. An example of the fluence-dependent debonding data for 1064 nm is shown in FIG. 3A for different loads. Similar debonding behavior was also observed for a two-part acrylic adhesive which had a lower maximum adhesive strength (FIG. 16).

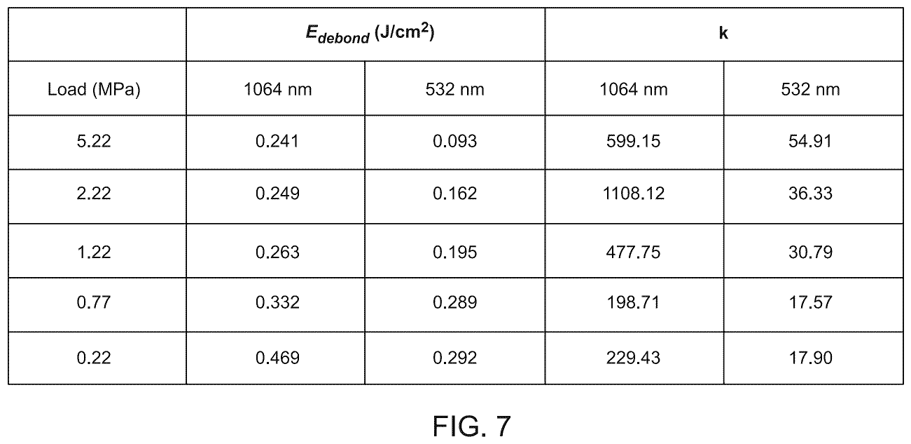

In order to extract quantitative information from FIGS. 3A-3B, the fraction of failed bonds (f_{debond}) was fit to a sigmoidal function of the form

$${f}_{d e b o n d} = \frac{1}{1 + exp [ k ( E - {E}_{d e b o n d} ) ]} \qquad ( 1 )$$

where E_{debond} is the threshold pulse fluence where 50% of the bonds fail and k is a stiffness parameter that measures the steepness of the sigmoidal transition around E_{debond}. The linear-least-squares fits using Equation (1) are overlaid with the data in FIGS. 3A and 3B. FIG. 7 is a table that summarizes the k and E_{debond} values for different loads and laser wavelengths for the cyanoacrylate glue. In accordance with an embodiment, a lower laser fluence could initiate debonding when the bond experienced a higher load. This dependence was relatively weak, however, with the debonding threshold changing by only a factor of 2 as the load changed by a factor of 25. The laser-induced debonding also depended on the laser wavelength, as shown in FIG. 3B. E_{debond} was 2-3× lower for 532 nm light. The variation in k values is not systematic for 1064 nm and probably reflects uncertainty in the fit, given the sparse number of data points around E_{debond}. However, the sigmoidal transition was always more gradual for 532 nm, with k values at least 10× smaller than for 1064 nm. Since a smaller k value indicates more variability in the detachment process around E_{debond}, the lower k values for 532 nm may reflect greater variation in energy transfer during the absorption process.

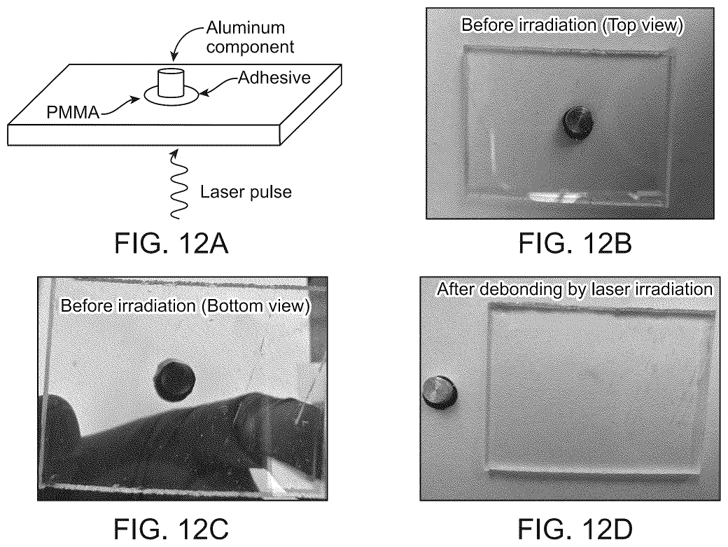

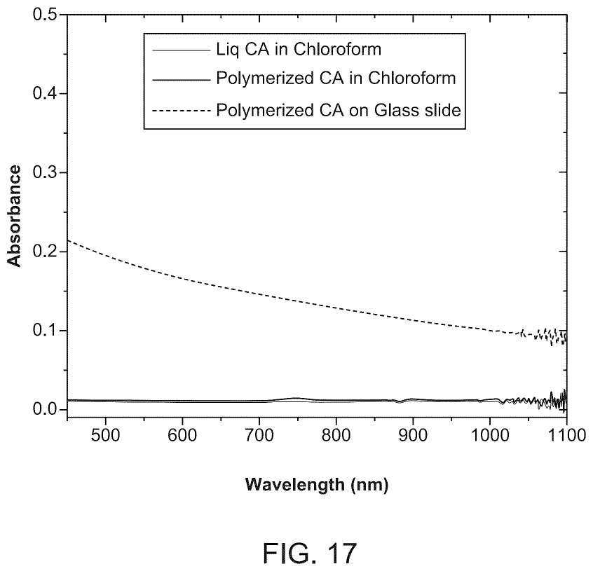

In order to confirm the physical picture of the laser-induced debonding process shown in FIG. 1, the following control experiments were performed. First, an experiment was performed to confirm that laser interaction with the Al surface is responsible for debonding. The laser pulse was expected to travel through both the PMMA and the acrylate glue with some loss due to scattering but no appreciable absorption. The cyanoacrylate glue had negligible absorption in the range 450 nm to 1100 nm in solution (FIG. 12). After polymerization, the solid cyanoacrylate became slightly cloudy and exhibited a long scattering tail in this wavelength range. The polymerized glue did not have a true absorption in this spectral region as shown by redissolving it in CHCl₃ and taking the absorption spectrum without a scattering background (FIG. 17). When cyanoacrylate was used to bond two transparent PMMA substrates, no laser debonding was observed, which confirmed that debonding could not be initiated by light absorption in the glue or PMMA. Whether debonding required nanosecond pulsed excitation was also checked. When a continuous wave (cw) laser supplying 2 W at 532 nm was directed onto a sample under a load of 0.44 MPa, no de-bonding or weakening was observed even after 2 hours of irradiation. The total amount of energy delivered to the glued interface by the cw laser was approximately 10⁵× greater than that supplied by a single 532 nm nanosecond pulse which easily debonded the sample. Thus, it was concluded that nonequilibrium heating of the metal by the laser pulse was required for debonding.

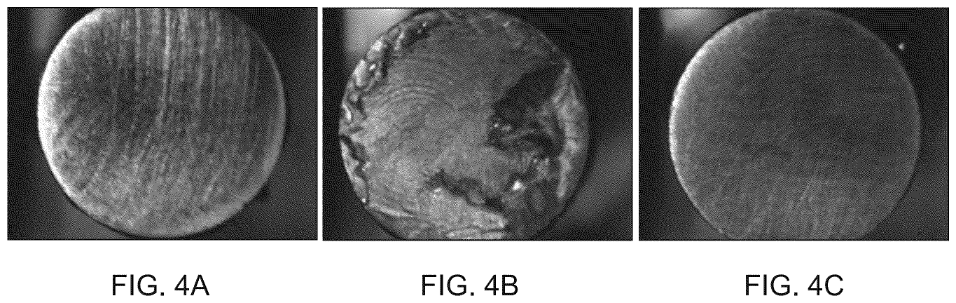

Further evidence for the role of laser-induced morphology changes in the metal surface was obtained by examination of the Al surfaces before and after debonding. A photograph of the polished Al surface before gluing is shown in FIG. 4A. After the Al piece was glued to the PMMA surface, there were two ways that it could be detached. Simply increasing the load resulted in cohesive failure where the rupture occurred inside the glue, so that a significant amount remained attached to both the Al and PMMA surfaces. This can be seen from the debris in the microscopy image in FIG. 4B. On the other hand, when a high-power laser pulse was used for debonding, the detached Al surface appeared smooth and clean, with no visible residue (FIG. 4C). Closer inspection of these surfaces using SEM revealed nanoscale changes in the surface morphology before and after laser debonding.

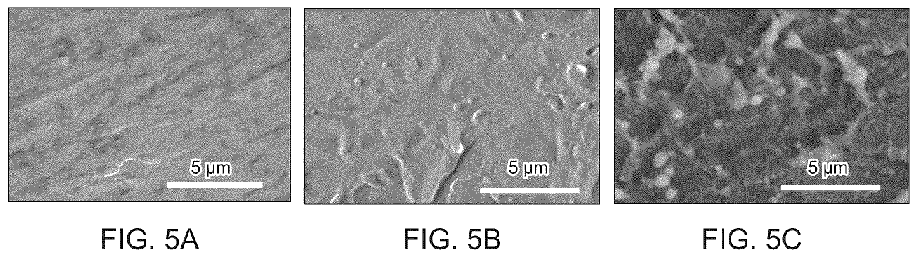

FIG. 5A shows the hand polished Al surface before gluing. The microscale ridges produced by sanding were required for the acrylate to form a strong adhesive bond, as recommended by the manufacturer. After laser impact, the bare Al surface in FIG. 5B showed clear signs of melting, with a complete loss of the ridges seen in FIG. 5A. When the Al surface was exposed to the same laser fluence as part of a bonded surface to PMMA, the melted Al surface was covered with a thin layer of insulating organic that appeared black in the SEM images (FIG. 5C). This organic layer is not visible in the optical microscopy images in FIGS. 4A-4C and is less than 1 micron thick. The organic layer can be attributed to a residue of decomposed cyanoacrylate glue.

In accordance with an embodiment, the results show that fluences above 0.5 J/cm² permit even very light loads to be detached in a single shot. The observations of detachment at the glue-Al interface, along with clear indications of melting of the Al surface, suggests that the debonding is driven primarily by metal melting that destroys the glue-Al adhesion. The fluences required for debonding, for example, lie in the range for Al melting (0.2-0.4 J/cm²) but below the fluence thresholds for more destructive processes like vaporization (1.5 J/cm²), plasma formation (1.5-3.6 J/cm²) and phase explosion (7 J/cm²). Surface melting would disrupt all organic-metal adhesive interactions, whether they rely on mechanical interlocking or chemical bonding. The greater absorption of Al at 532 nm would make this wavelength more effective at heating and melting the solid metal, which explains its lower E_{debond} values. A similar enhancement factor for 532 nm has been observed for Al plasma formation and ablation, which also rely on efficient absorption of the laser wavelength.

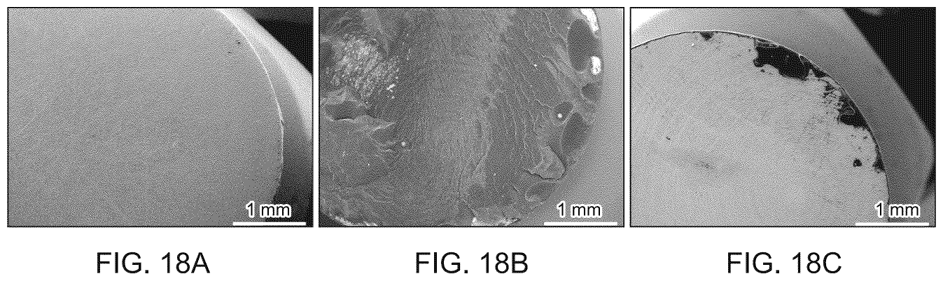

An interesting question is why E_{debond} depends on load. One might expect that once the surface melting occurs, any load will be detached. However, it is possible that some adhesion at the periphery is not completely destroyed, as evidenced from SEM images at lower magnification (FIGS. 18A-18C). Also, there may be local regions of stronger bonding due to surface variations where some adhesion survives the laser pulse. Two simple physical models were considered for the effects of residual bonds on the debonding energy E_{debond}. Before the laser pulse, it was assumed that the Al-glue interface is held together by an effective bond density given by

$${N}_{b}^{0} .$$

After the laser interacts with the Al surface, the bond density is reduced to N_{b}. If one assumes that the load required to break the surviving bonds (L_{debond}) is linearly dependent on the number of surviving bonds N_{b}, one will have:

$${L}_{d e b o n d} = A {N}_{b} \qquad ( 2 )$$

where A is an undetermined constant. In accordance with embodiment, one can postulate some analytical models for how N_{b} depends on the pulse energy fluence. First, an exponential decrease for N_{b} can be assumed once the laser fluence E surpasses some threshold E₀. E₀ can be thought of as the energy required to start breaking bonds, for example by melting the surface. In this case,

$${N}_{b} = {N}_{b}^{0} exp [ - {k}_{b} ( E - {E}_{0} ) ] \qquad ( 3 )$$

Alternatively, one can postulate an inverse dependence on E,

$${N}_{b} = \frac{{N}_{b}^{0}}{1 + {k}_{b} ( E - {E}_{0} )} \qquad ( 4 )$$

By substituting Equations (3) and (4) back into Equation (2), setting E=E_{debond}, and rearranging, two possible expressions for the dependence of E_{debond} on L_{debond} were obtained. From Equation (3),

$${E}_{d e b o n d} ( {L}_{d e b o n d} ) = {C}_{1} - \frac{ln ( {L}_{d e b o n d} )}{{k}_{b}} \qquad ( 5 )$$

was obtained, while Equation (4) yields

$${E}_{d e b o n d} ( {L}_{d e b o n d} ) = {C}_{1} + \frac{{C}_{2}}{{L}_{d e b o n d}} \qquad ( 6 )$$

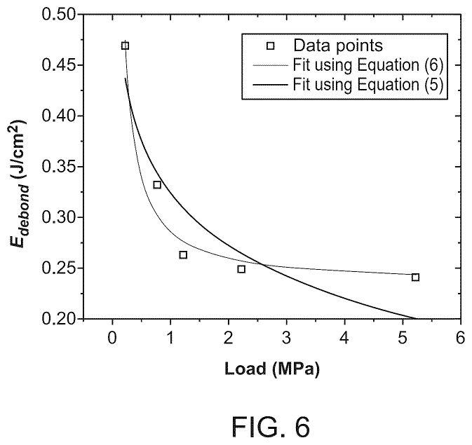

FIG. 6 plots E_{debond} versus L_{debond} for 1064 nm pulses, along with fits using Equations (5) and (6). The fit using Equation (6) is does a significantly better job of reproducing the rapid initial decay and plateau at higher load values. From a physical standpoint, once the pulse energy exceeds E₀, Equation (4) suggests that the residual bonding drops very rapidly with increasing E, allowing one to be confident that a fluence greater than 0.5 J/cm² will detach all but the lightest loads. However, it should be noted that this model does not take into account complicating factors like the spatial variation of laser intensity across the bonded surface or the possible role of chemical decomposition and vaporization of the organic layer. Nevertheless, it is encouraging that this simple model provides an adequate fit to the data.

In accordance with an embodiment, the laser pulsed debonding of strong adhesives has been characterized. The laser melting process produces relatively clean breaks with minimal damage to the Al surface, and the process is fairly insensitive to the nature of the adhesive or the applied load. High power nanosecond pulses can be propagated though optical fibers and transparent solids with low loss and negligible dispersion, making it relatively straightforward to deliver the laser energy to the adhesive interface. The main limitation of this technique is the requirement that one of the bonded materials be transparent at the laser wavelength, while the other must be an absorbing metal. In accordance with an embodiment, making nanosecond laser debonding practical, one would need to identify transparent materials that can be used as structural elements in combination with metals.

### B. Si-Eva Debonding:

Solar cells are at the forefront of our transition away from fossil fuels. They comprise a crystalline silicon (Si) layer sandwiched between a plastic substrate and a protective ethylene vinyl acetate (EVA) layer that is adhered to a glass plate. This encapsulation allows solar panels a lifespan of ca. 25 years but makes them difficult to recycle because of the high-strength bonding between the substrate and EVA adhesive. Current separation methods involve grinding, heating, and solvent soaking. To separate the glass/EVA layer from the Si wafer, localized impulse heating via pulsed laser irradiation can lead to debonding of the two interfaces.

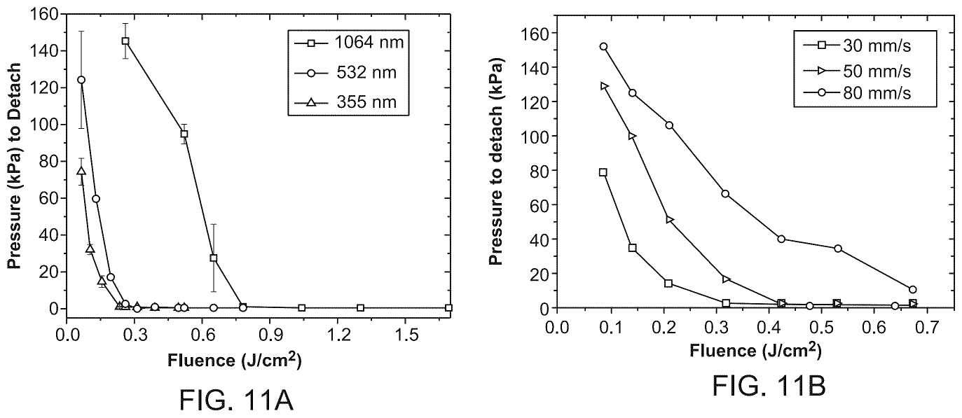

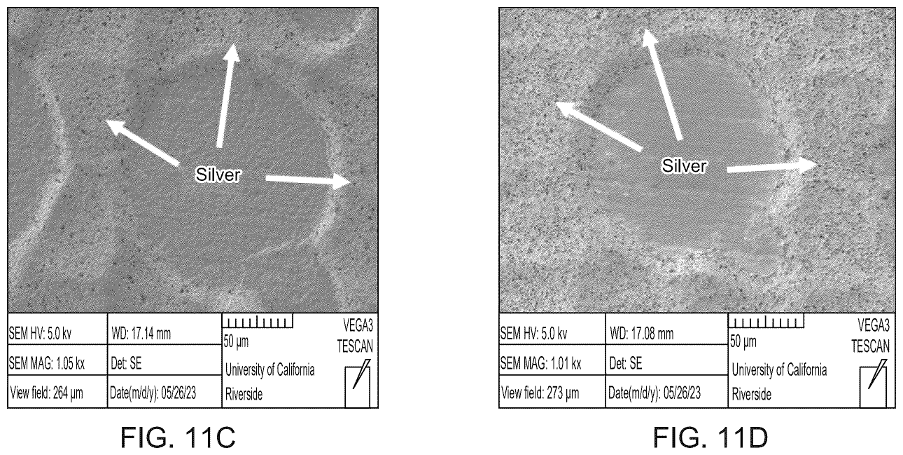

As a proof-of-concept study, a 0.3 mm thick EVA film (33% vinyl acetate content, eBay) was sandwiched between a hand-roughened microscope glass slide (Eisco Labs, USA) and a commercially available silicon (Si) wafer (AOSHIKE 0.5V 400 mA polycrystalline silicon solar cell, Amazon) by heat treatment on a hot plate (Fisher Scientific, USA) for 15 minutes at 160° C., followed by slow cooling by turning off the heating of the hot plate and leaving the sample on the heater for ~15 mins. A 1 cm×1 cm area of EVA laminated area was prepared following this method. Next, the backside of the Si wafer was glued to another glass slide with UV-curing glue (Ultrabond 721, Hernon) in a cross-shape manner. This cross-shaped structure allowed the application of external force while irradiating the bonded area. A pulsed laser (Amplitude Surelite II-10) with a five-nanosecond pulse width and 10 Hz repetition rate was used for pulsed laser irradiation at different wavelengths (355 nm, 532 nm, and 1064 nm) (FIGS. 10A-10D). Different laser fluences (pulse energy over the area) led to the separation of the EVA/glass slide from the Si wafer with some external force. To irradiate the laser beam over one square centimeter, a computer-controlled motorized x-y translation stage (Zaber, Canada) was used for the variable speed raster scanning of the homemade Si-EVA-glass assembly. The external load on the solar panel and scanning speed in the motorized stage were varied to optimize the parameters (FIGS. 11A-11D). Optical and SEM images were taken to examine the surface morphology of the Si wafer before and after laser irradiation.

C. Metal Debonding with Black Electronic Epoxy for Reworkable Electronics:

Expensive electronic devices/components, like integrated circuits, can be re-used if they can be detached from the circuit board on which they were originally installed. The pulsed laser debonding method can aid in the dismantling of end-of-life electronic devices/printed circuit boards (PCB) if appropriately designed. One challenge with this application is that the electronic epoxied are typically black in color, which might be expected to prevent the light from reaching the absorbing interface.

As a proof-of-concept study, as shown in FIGS. 12A-12D, a transparent PMMA sheet (McMaster-Carr, USA) was attached to an aluminum (Al) piece with a 2-part black industrial adhesive (DP270, 3M, USA) typically used for bonding electronic and electrical components. The adhesive was cured between the Al piece and the PMMA board under light pressure for more than 24 hrs. A single 5 nanosecond, 1064 nm wavelength laser pulse (Amplitude Surelite II-10) could detach the metal component from the transparent PMMA board despite being attached with the non-transparent, black epoxy adhesive.

D. Transparent-Transparent Debonding with Thin Absorbing Layer

Metal/opaque substrates are non-transparent to visible light, whereas transparent substrates let light pass through them. Most clear adhesives are also transparent to visible light when two transparent substrates are bonded with clear adhesives (e.g., cyanoacrylate). In order to detach two adhesively bonded transparent substrates, a thin layer of absorbing material must be introduced at the interface.

Three different dyes: Rose Bengal (Aldrich Chem. Co.), Malachite Green (Exciton) and Fluorescein 27 (Lambda Physics), were coated (spin coating/drop casting) on a transparent PMMA substrate with a machined rough surface. All three dyes absorb strongly at 532 nm. Another transparent PMMA post with a rough surface was then adhesively bonded to the coated substrate with a commercial cyanoacrylate adhesive (CA-8, 3M). The tensile strength of the bonded joints was tested with a home-built and calibrated tensile strength testing setup to measure the joint strength. Sample joints were also laser irradiated with a 5 nanosecond, 532 nm laser pulse to study the deadhesion behavior. Although all absorbers showed light-induced debonding, Fluorescein 27 was the optimum dye that allowed the joint to hold higher loads while also allowing separation with a single-shot laser pulse. For all experiments, the bonded area was smaller than the beam spot size (0.65 cm). For the rest of the experiments, only Fluorescein 27 was studied due to its superior performance.

Different concentrations (0.011, 0.022, 0.055, 0.114 and 0.228 M) of Fluorescein-27 dye were prepared in an ethanol/aqueous NaOH solution. 60 μL of the sample solution was spin-coated on the PMMA substrate (1000 rpm, 30 seconds) using a spin coater (WS-400-6 npp/lite, Laurell, USA) and allowed to dry for 1 min. The spin coated layer thickness was calculated to be around a few hundred nanometers. A machined PMMA post was attached to the coated substrate with the commercial cyanoacrylate adhesive and left to cure for at least 24 hours under light pressure as per the adhesive manufacturer's instructions.

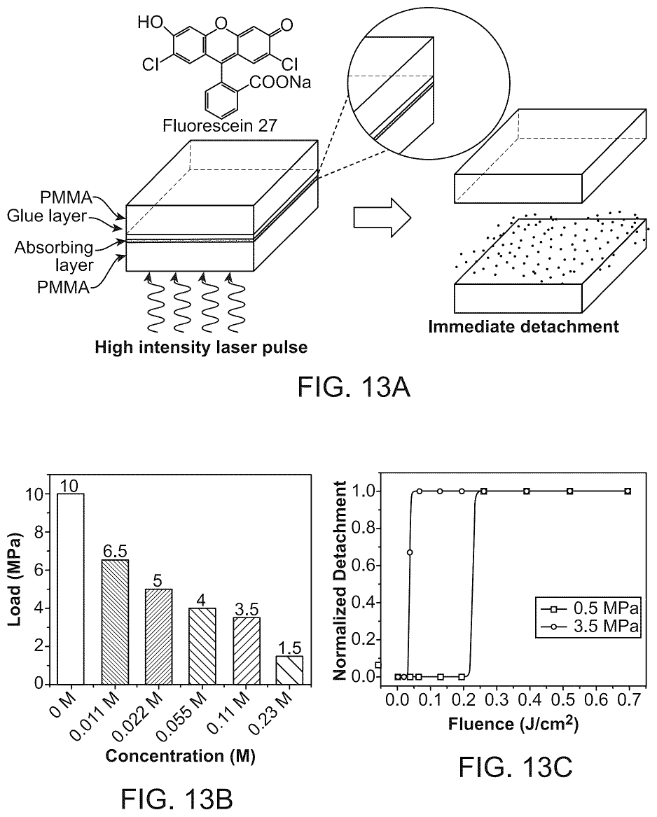

The bonded joint strengths were tested under different loading conditions with a custom-built 2-pulley setup which allowed laser irradiation. Introducing the absorbing layer at the interface did not change the colligative properties of the adhesive. However, it reduced the overall strength of the joint when compared to a similarly prepared joint with no absorbing layer (FIG. 13A-13D). Under two different external pressures (0.5 MPa and 3.5 MPa), the detachment behavior was studied under different laser fluence conditions at 532 nm wavelength, and it was found that average fluences of 0.038 J/cm² and 0.227 J/cm² were necessary for debonding under 3.5 MPa and 0.5 MPa, respectively.

### F. Artificial Nail Deadhesion:

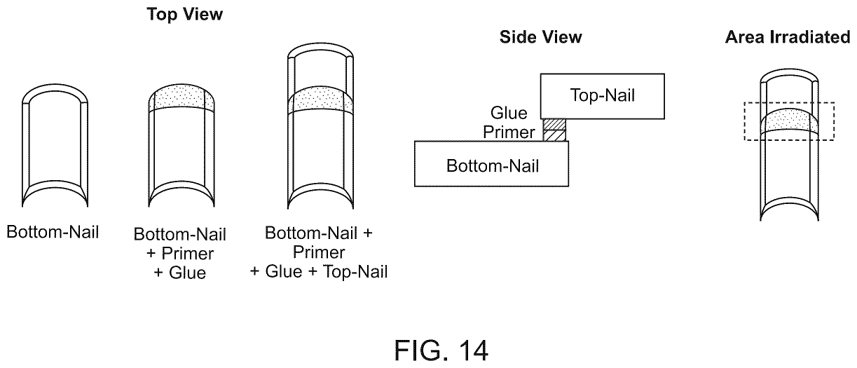

FIG. 14 illustrates a method for artificial nail deadhesion in accordance with an embodiment. Fine-grit sandpaper was passed over the top 3 mm of the surface of a plastic-based artificial nail (AN) to make the “Bottom-Nail”. The process was repeated for a second AN, but on the underside of the AN to make the “Top-Nail”. The top of the AN is analogous to the end or tip of a fingernail and differs from the base of the AN which is analogous to the area closest to the nailbed. Subsequently, the surface of the sanded AN was wiped with a Kimwipe and the top 3 mm of the Bottom-Nail was painted with one coat of a light-absorbing primer layer, which was allowed to dry for 3 minutes. A second coat of primer was applied and allowed to dry for 3 minutes. Several different light-absorbing primer layers were prepared, all of which were suspensions of the absorbers (Carbon (Alfa Aesar, #45537); Iron(II,III) oxide powder (Sigma-Aldrich, #518158); Iron(II,III) oxide powder <5 mm 95% (Sigma-Aldrich, #310068)) mixed in a colorless, clear nail polish (Orange Beauty Supply, Riverside, CA). Concentrations ranged from 0.1%-10% by weight. Test-Nails were also painted with nail polish, including gel polish, such that the entire Test-Nail was fully painted.

An aliquot (<2 microliters) of a cyanoacrylate-based glue was applied to the top ⅛″ of the primed Bottom-Nail such that it was spread over the area evenly. The Top-Nail was adhered to the Bottom-Nail in similar fashion as is performed by an individual or a nail technician, where the Top-Nail extends out from the Bottom-Nail to make the Bottom-Nail longer in length. The geometry of the Top and Bottom Nail adhesion is shown in FIG. 14. The two nails (Test-Nail) were held together for 10 seconds with moderate pressure by hand and then allowed to dry for 2 minutes. Experiments were performed within 24 hours after a Test-Nail was created.

The Test-Nail was secured on an X-Y scanning stage (Zaber) such that the Top-Nail was facing upward, with the underside of the Test-Nail adhered to the stage with Earthquake Putty. Zaber's software was used to control the direction (X, Y) of the scanning stage and the step size (2 mm) of each step. A Q-switched Nd: YAG laser (Surelite, Continuum, Milpitas, CA) with a 10 ns pulse width at 1064 nm was used as the irradiation source with pulse energies of 650 mJ, 300 mJ, 150 mJ, and 100 mJ. The laser beam diameter was 6.7 mm, and it was moved in 2 mm increments until the Top-Nail detached from the Bottom-Nail.

One laser shot was used to irradiate the sample at each step on the Test-Nail. The laser beam was directed to the Test-Nail by a mirror, and the Test-Nail was moved using the scanning stage to irradiate a new spot. The area that was irradiated was at the glued interface between the two ANs, which had approximate dimensions of 3 mm by 8 mm. It was observed that at 650 mJ for all concentrations and primers tested, the Top-Nail popped off after 1-3 irradiation spots were scanned. With decreasing primer concentration and decreasing power, more irradiation spots were often needed (2-4 rows of 2 mm increments). The number of irradiation spots and rows were hypothesized to depend on the area that the glue extended to where the two ANs were attached and if all glued areas were irradiated.

### G. Nail Polish Removal:

Fine-grit sandpaper was used to buff the surface of an artificial nail (AN). Subsequently, the surface of the sanded AN was wiped with a Kimwipe and painted with one coat of light-absorbing primer The light-absorbing primer was a suspension of the test absorbers: Carbon (Alfa-Aesar, #45537); Iron(II,III) oxide powder (Sigma-Aldrich, #518158); Iron(II,III) oxide powder <5 mm 95% (Sigma-Aldrich, #310068), each mixed into a colorless, clear nail polish (Orange Beauty Supply, Riverside, CA). Concentrations ranged from 0.1%-10% by weight. The AN was then painted with nail polish (red, white, black, blue; OPI and Sally Hansen bands; Target, Moreno Valley, CA; or red gel from Orange Beauty Supply, Riverside, CA). Two or three coats of nail polish were applied. Only one coat of gel was applied before curing with a UV-light, per product instructions. Each sample was left to dry for 2 hours. Each experiment was performed within 24 hours of the samples being prepared. The Test-Nail was secured on an X-Y scanning stage (Zaber) such that the Top-Nail was facing upward, with the underside of the Test-Nail adhered to the stage with Earthquake Putty. Zaber's software was used to control the direction (X, Y) of the scanning stage and the step size (2 mm) of each step. A Q-switched Nd: YAG laser (Surelite, Continuum, Milpitas, CA) with a 10 ns pulse width at 1064 nm was used as the irradiation source with pulse energies of 650 mJ, 300 mJ, 150 mJ, and 100 mJ. The laser beam diameter was 6.7 mm.

One laser shot was used to irradiate the sample at each step on the Test-Nail. The laser beam was directed to the Test-Nail by a mirror, and the Test-Nail was moved using the scanning stage to irradiate a new spot. At the spot where the laser irradiated the Test-Nail the top paint or gel layer was detached after a single laser pulse.

### Experimental Setup:

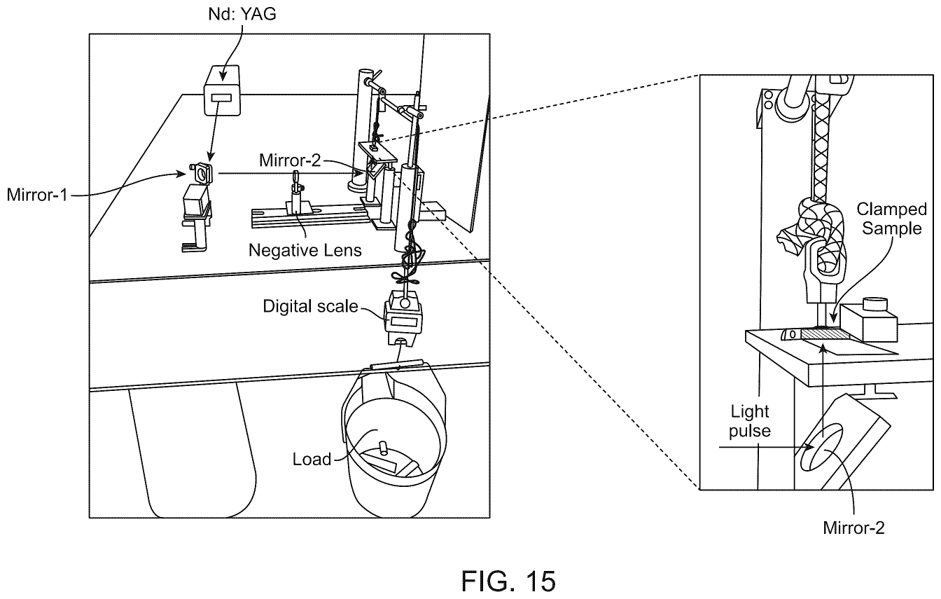

FIG. 15 is an illustration of an experimental setup with 2-pulley system for measuring adhesive strength and pulsed laser-based deadhesion.

FIG. 16 shows the fraction of samples that debonded plotted versus laser pulse fluence for 1064 nm pulses. The sample was Al-glue-PMMA where the glue was a 3M 2-part acrylic adhesive, basically a standard mixed epoxy. The sample was held under a 1.5 MPa load. The blue line is a fit to the data using the sigmoidal function given in Equation (1).

FIG. 17 is an illustration of UV-Vis absorption spectra of 3M Ethyl Cyanoacrylate (CA) Instant Adhesive dissolved in chloroform solution before polymerization (black), in solid polymerized form on a glass slide (blue) and the polymerized glue redissolved in chloroform (black). The glue has no measurable absorption at the laser wavelengths of 1064 nm and 532 nm.

FIGS. 18A-18C are reflective SEM images of a 5 mm diameter Al surface before gluing; Al surface after physical debonding by the application of a 10 MPa load, leaving residual adhesive and PMMA debris on the surface; and Al surface after laser debonding (0.78 J/cm²) with minimal residue left behind around the edges, respectively.

### Physical Models for Debonding:

In accordance with an embodiment, to understand the debonding phenomenon, two physical models with some assumptions listed below were proposed:

### Assumptions:

i.

$${N}_{b}^{o} = Effective bond density between A1 - PMMA interface before irradiation and$$

N_{b}=bond density remaining after pulsed laser irradiation
ii. Bonds are broken only after fluence surpasses a threshold fluence E₀
iii. Load required (L_{debond}) to breach the surviving bonds is linearly dependent on the number of surviving bonds N_{b}
   Thus, Load, L_{debond} ∝N_{b} at detachment

$$Or , Load , {L}_{d e b o n d} = A {N}_{b} \qquad ( 7 )$$

Where, A=proportionality (undermined) constant

### Model 1:

In the first model, an exponential decrease for N_{b} was assumed once the laser fluence E surpasses a threshold value E₀, where E₀ represents energy required for breaking the adhesive bonds.

$$Hence , {N}_{b} = {N}_{b}^{o} exp [ - k ( E - {E}_{o} ) ] \qquad ( 8 )$$

Substituting Equation (8) in Equation (7) and setting E=E_{debond}, one gets

$${L}_{d e b o n d} = A {N}_{b} = A {N}_{b}^{o} exp [ - k ( {E}_{d e b o n d} - {E}_{o} ) ] \qquad ( 9 )$$

$$ln ( {L}_{d e b o n d} ) = ln ( A {N}_{b}^{o} ) - k ( {E}_{d e b o n d} - {E}_{o} )$$

$${kE}_{d e b o n d} = ln ( A {N}_{b}^{o} ) + k {E}_{o} - ln ( {L}_{d e b o n d} )$$

$${E}_{d e b o n d} = \frac{ln ( A {N}_{b}^{o} ) + k {E}_{o}}{k} - \frac{1}{k} ln ( {L}_{d e b o n d} )$$

$${E}_{d e b o n d} = {C}_{1} - ( \frac{1}{k} ) ln ( {L}_{d e b o n d} )$$

$$Here ,$$

$${C}_{1} = \frac{ln ( A {N}_{b}^{o} ) + k {E}_{o}}{k}$$

And C₁ and k are fitting parameters

### Model 2:

In the second model, an inverse dependence of Ngon E was postulated.

$${N}_{b} = \frac{{N}_{b}^{o}}{1 + k ( E - {E}_{o} )} \qquad ( 10 )$$

Setting E=E_{debond} and inserting Equation (10) in equation (7), one gets

$$Load , {L}_{d e b o n d} = A {N}_{b} = \frac{A {N}_{b}^{0}}{1 + k ( {E}_{d e b o n d} - {E}_{0} )} \qquad ( 11 )$$

Rearranging sides, one gets

$$1 + k ( {E}_{d e b o n d} - {E}_{o} ) = \frac{A {N}_{b}^{o}}{{L}_{d e b o n d}} \qquad ( 12 )$$

$${E}_{d e b o n d} = {E}_{0} + ( \frac{A {N}_{b}^{0}}{{L}_{d e b o n d}} - 1 ) \frac{1}{k}$$

$${E}_{d e b o n d} = {E}_{o} - \frac{1}{k} + \frac{A {N}_{b}^{o} / k}{{L}_{d e b o n d}}$$

$${E}_{d e b o n d} = {C}_{1} + \frac{{C}_{2}}{{L}_{d e b o n d}}$$

Here, C₁ and C₂ are fitting parameters.

The fluence values (E_{debond}) were fitted against different loads with Equation 9 and Equation 12.

The detailed description above describes embodiments of a method and system for pulsed light deadhesion for metal-transparent and transparent-transparent substrates attached with adhesives. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

1.-26. (canceled)

27. A method for debonding an adhesive polymer layer, comprising:
providing a multilayer assembly comprising:
a first substrate, wherein the first substrate is optically transparent to incident high-intensity pulsed light within a specified wavelength range between 355 nm to 1064 nm;
an adhesive polymer layer positioned between the first substrate and a second substrate; and
a second substrate, wherein the second substrate is configured to absorb incident light energy through one or more mechanisms, wherein the one or more mechanisms include:
the second substrate is optically non-transparent, enabling absorption of the incident light energy to induce localized phase changes at an interface between the adhesive polymer layer and one or more of the first layer and the second layer, the induced localized phase changes includes one or more of melting and re-solidification, resulting in a disruption of adhesive bonds; or
the second substrate is optically transparent but incorporates light-absorbing species on a surface of the second substrate, wherein the light-absorbing species absorb the incident light energy, inducing phase changes through decomposition; and
transmitting pulsed light through the first substrate, wherein the energy is directed to the adhesive polymer layer and the second substrate to selectively weaken or disrupt the adhesive bonds, enabling controlled separation of the first and second substrates.

28. The method according to claim 27, further comprising:
debonding the interface between the adhesive polymer layer and the one of the first substrate and the second substrate with the source of pulsed light, the pulsed light within a specified range of 355 nm to 1064 nm of the electromagnetic wave spectrum.

29. The method according to claim 27, further comprising:
applying pressure to one or more of the first substrate and the second substrate after transmitting the pulsed light through the first substrate; and
separating the adhesive polymer layer from the one or more of the first substrate and the second substrate.

30. The method according to claim 27, wherein the interfacial layer of light absorbing species has a width of 10 microns or less.

31. The method according to claim 27, wherein the second substrate is optically transparent, and further comprising:
depositing an absorbing layer on one of the optically transparent first substrate or the optically transparent second substrate before applying the adhesive layer.

32. The method according to claim 31, further comprising:
detaching the adhesive layer from the one of the optically transparent first substrate or the optically transparent second substrate having the absorbing layer by inducing a phase change of the absorbing species, the phase change being one of a melting, a pyrolysis, or a vaporization, with phase change leading to a volume expansion that ruptures the adhesive bonds.

33. The method according to claim 31, wherein the absorbing layer preserves colligative properties and adhesive strength of the adhesive layer during the transmitting of the source of pulsed light through the first substrate.

34. The method according to claim 31, wherein the second substrate is a metal or semiconductor substrate, and further comprising:
detaching the adhesive layer from the metal or semiconductor substrate by melting a surface of the substrate.

35. The method according to claim 27, wherein the source of pulsed light is a high energy nanosecond laser pulse at one or more of 355 nm, 532 nm and 1064 nm.

36. The method according to claim 27, wherein the adhesive layer is a cyanoacrylate, a 2-part epoxy, or an adhesive glue.

37. The method according to claim 27, wherein the adhesive layer is a glue, the first substrate is polymethyl(methacrylate) (PMMA), polycarbonate or any carbon-based transparent polymer or glass, and the second layer is aluminum, steel or any semiconductor material.

38. The method according to claim 27, wherein the adhesive layer can be de-bonded from an aluminum substrate without the requirement of any external axial, peel, and shrink force for laser fluence greater than 0.6 J/cm² for 1064 nm wavelength and 532 nm wavelength laser pulses and without damaging the aluminum substrate through ablation.

39. The method according to claim 27, further comprising:
transmitting the source of pulsed light in one or more of a single-shot pulsed laser or a source of high intensity light, the source of high intensity light being a flash-lamp or a pulsed light emitting diode.

40. The method according to claim 39, wherein the single-shot pulsed laser has a 5 nanosecond (ns) pulse width or a duration less than a characteristic thermal diffusion time across the absorbing layer.

41. The method according to claim 27, wherein the first substrate or the second substrate is selected from one or more of a mechanical fastener, a beauty care product, a transparent circuit board, photovoltaic solar panel wafer or a plastic component.

42. A system for debonding of an adhesive from a substrate, the system comprising:
a first substrate, the first substrate being an optically transparent substrate;
an adhesive layer arranged between the first substrate and a second substrate; and
wherein the first substrate and the adhesive layer are configured to receive a source of pulsed light that is transmitted through the first substrate and the adhesive layer to the second layer.

43. The system according to claim 42, wherein
an interface between the adhesive layer and the second substrate is debonded with the source of pulsed light, the interface has a width of 10 microns or less; and
the second substrate is optically transparent, and an absorbing layer is deposited on one of the optically transparent first substrate or the optically transparent second substrate before applying the adhesive to form the adhesive layer.

44. The system according to claim 42, wherein the light-absorbing species deposited on the second transparent substrate can be organic or inorganic dye, metal/metal oxide nanoparticles, and the adhesive layer is configured to be detached from the one of the optically transparent first substrate or the optically transparent second substrate having the absorbing layer by inducing a phase transition in the absorbing layer, the phase transition being a melting, a pyrolysis, or a vaporization in the absorbing layer.

45. The system according to claim 43, wherein
the absorbing layer preserves colligative properties and adhesive strength of the adhesive layer during the transmitting of the source of pulsed light through the first substrate;
the second substrate is a metal substrate, and the adhesive layer is configured to be detached from the metal substrate by melting a surface of the metal substrate; and
the source of pulsed light, the source of pulsed light being a high energy nanosecond laser pulsed at one or more of 355 nm, 532 nm and 1064 nm.

46. The system according to claim 43, wherein
the adhesive layer is a cyanoacrylate, a 2-part epoxy, or an adhesive glue, and the first substrate is polymethyl(methacrylate) (PMMA), and the second layer is aluminum; or
the first substrate or the second substrate is selected from one or more of a mechanical fastener, a beauty care product, a transparent circuit board, photovoltaic solar panel wafer, or a plastic component.
